(19) United States
(12) Patent Application Publication
(10) Pub. No.: US 2022/0092557 A1
(43) Pub. Date: Mar. 24, 2022

(54) METHOD AND SYSTEM FOR DYNAMICALLY PREPARING AN IMAGE-BASED REPAIR PLAN

(71) Applicant: OEMiQ Automotive Technology ULC, London, CA (US)

(72) Inventors: Paul Antony, London (CA); Jasson Cohen, Wellesley, MA (US); Tanya Sweetland, Milwaukie, OR (US); Anthony Bidner, London (CA); Stephen Taylor Moss, Highland, UT (US)

(21) Appl. No.: 17/377,974

(22) Filed: Jul. 16, 2021

Related U.S. Application Data
(60) Provisional application No. 63/056,002, filed on Jul. 24, 2020.

(51) Int. Cl. G06Q 10/00; G06F 3/01; G06T 19/20; G06T 19/00

(52) U.S. Cl. CPC G06Q 10/20; G06F 3/011; G06T 2200/24; G06T 19/006; G06T 2200/04; G06T 19/20

(57) ABSTRACT

A method of and system for dynamically preparing an image-based repair plan for a damaged motor vehicle and for preparing an interactive repair that includes an image of the vehicle, as well as metadata that have been tagged onto the image, for use by repair technicians.

### CROSS-REFERENCE TO RELATED APPLICATION

This application is a non-provisional of and claims priority to and the benefit of U.S. Patent Application No. 63/056,002 filed on Jul. 24, 2020, the disclosure of which is incorporated herein by reference in its entirety.

### BACKGROUND

Accidents and other events involving damage to a motor vehicle, absent a total loss, require repair subject to approval by the owner of the motor vehicle, while the insurer (if present) determines how much of the cost of repairs is covered under the owner's/insured's insurance policy and compensates the repairer for the work. Typically, after the accident or other cause of damage, the owner (or other interested party) initiates a first notice of loss by calling or otherwise contacting her insurance carrier (the “insurer”) to report the incident. The insurer, in turn, may provide the owner/insured with a list containing one or more suggested repair facilities to which the owner/insured may have the vehicle delivered for repairs. Often, the repair facilities listed have been selected by the insurer because the facilities participate in an insurer-sponsored program, e.g., a Direct Repair Program (“DRP”).

Conventionally, insurers pre-screen and actively monitor DRP repair facilities to assess each facility's ability to satisfy several industry metrics, chief of which include: the cycle time (i.e., how quickly the facility historically effects repairs), performance against the insurer's cost estimate of repairs (the “insurance estimate”), and so forth. Each DRP repair facility is required to generate its insurance estimate using a software application (“Estimating App”), which is then sent to the insurer and approved/denied. Repairers and insurers may spend many hours and days negotiating initial repair costs (and re-negotiating through supplements as the repair is completed), which impacts customer satisfaction. In some cases, if the insurer refuses to pay for the required repairs, the repairer is forced to choose between losing profitability and deviating from the desired/required repairs. In short, DRP programs and Estimating Apps create a dynamic whereby the cost of repairs and related economic/performance pressures drive not only which repair facility repairs the vehicle, but decision making within the shop; this economic incentive may, at times, supersede the proper and complete repair of the vehicle.

At the repair facility, after the insurance estimate is generated, members of the repair team (e.g., those responsible for repair research, who are sometimes called repair planners, blueprinters, technicians and/or shop managers) may research repair procedures (“RPs”) created by the vehicle manufacturers/Original Equipment Manufacturer (“OEMs”) to better understand how to perform specific repairs. As the designer and manufacturer of the vehicle, OEMs remain the singular “source of truth” for how to properly and safely repair and return the damaged vehicle to its pre-loss condition and operation, to the extent possible.

Typically, RPs are generated by OEMs for the purpose of providing in-depth instructions and reference material for how to properly repair their vehicles. Conventionally, RPs are generated at the time the vehicle is designed and manufactured and may be updated as required thereafter (e.g., in the event of a recall, when an error is discovered in the RPs, or the like). As a result, most repair facilities, on occasion and as/when they deem necessary, research RPs to understand how to repair damaged vehicles properly and safely. These RPs are typically available online via difficult to navigate websites (e.g., the OEM's website, the websites of third-party aggregators, and so forth), are highly non-standard (e.g., OEMs handle different things within the content differently, and things are often inconsistent within the same OEM's content) and lack a modern user interface, making them difficult to access, consume, and share. Disadvantageously, most repair facilities focus initially on the insurance estimate and research RPs as a second step (if at all), which frequently results in overlooking an activity, a step, or a part. Notably, while the Estimating Apps and others have provided limited tools for accessing RPs via their interface, including via “estimate appending”, or the identification of RPs after the generation of the insurance estimate itself (although this will only include items on the insurance estimate; i.e., if it was missed on the insurance estimate then the RPs will by definition not be available), they generally do not contain comprehensive OEM repair information or have direct communication with the OEMs. This “insurance estimate first” approach, combined with the economic incentive to keep costs down given the insurer-focused objectives overall, limits the utility of RPs within the repair process. As vehicles become increasingly complex and technicians increasingly leave the industry, the importance of RPs to the repair process (and the frustration that repair facilities have with current access tools) is increasing.

Conventionally, any number of RPs necessary for the complete repair of a damaged vehicle may be aggregated to create a plan, methodology, compilation, or sequence of steps and/or procedures to be undertaken to effect the necessary repair of the damaged vehicle (a “repair plan”). Heretofore, aggregating RPs into a repair plan—if it is done at all—has been a manual process, involving printed documents passed between shop employees. An employee tasked with this responsibility typically appends the insurance estimate or accesses an OEM directory/third party aggregation Website to search through RPs for what he or she believes are the most relevant. He or she may then choose which RPs, if any, to print and pass on to others on the repair team, including repair technicians. By its manual nature and dependency on dated repositories filled with hundreds of thousands of files and requiring the physical printing of paper, the process is highly prone to human error. Furthermore, in the infrequent cases when paper documents are not in use, electronic or digital RPs may only be available in a static format (e.g., HTML, PDF, and so forth), which can require similarly manual research and aggregation efforts and similarly contribute to human error. Moreover, the process of accessing electronic or digital RPs online differs from OEM to OEM, adding to the cognitive burden of researching RPs. Importantly, insurers do not typically reimburse repair facilities for the associated expense (e.g., subscription fees, human labor) which, combined with the fact that researching RPs may become confusing, burdensome, costly and time-consuming, may discourage repair planning and the use of RPs in general. The process is also ad hoc and lacks robust tools for governance and standardization, introducing the potential for significant variability in repair quality and resulting safety risk. Indeed, fewer than 20 percent of collision repair facilities report accessing one or more RPs on a regular basis. Considering that the typical repair may require the use of dozens of different RPs with instructions, diagrams, precautions, and references to sub-procedures, low utilization rates of RPs impact the quality of repair and the resulting safety of vehicle passengers post repair. While many technicians are highly skilled in the trade and have “done it before”, rapidly changing vehicle designs and models and turnover in the industry make these challenges increasingly acute.

Notwithstanding the relatively low percentage of repair facilities performing RP research, several state governments have proposed and/or enacted legislation that purports to require vehicles to be repaired using RPs while courts have held repair facilities liable for not properly repairing vehicles (in accordance with RPs).

### SUMMARY OF THE INVENTION

Accordingly, it would be advantageous to provide a comprehensive system, method, and application suite which provide enabling technologies to improve how RPs may be accessed, researched, utilized, aggregated (e.g., into repair plans), shared, analyzed, and archived to repair a vehicle that has been damaged (e.g., in a collision). In some implementations, such a method and platform may include the intelligent identification of useful information, including RPs, parts, cross-references between RPs, and the like, from a number of entities, including the OEM, and a feedback loop to accumulate comments and feedback on the RPs from the repair team and stakeholders who have an interest in the repair, such as third-party appraisers, insurer staff, the vehicle owner, etc. Accordingly, the platform and method may facilitate the proper and safe repair of a vehicle. This may also support (through more accurate repair) the value of the repaired vehicle by mitigating the extent of any diminution in value that vehicles typically experience after sustaining damage. At the same time, the platform and method may also create process efficiencies, improve governance and management controls, enhance the consumer experience, and (potentially) drive incremental value for the OEMs/repair facilities.

In a first aspect, embodiments of the present invention relate to an interactive image-based repair plan (a “Repair Plan”) for use on a user interface by at least one repair technician (or other repair professional) to repair a damaged motor vehicle. In some embodiments, the Repair Plan includes an (e.g., a three-dimensional) image of a motor vehicle that includes repair procedures from an original equipment manufacturer and metadata tagging that overlays the OEM repair procedures.

Advantageously, the Repair Plan is workflow enabling and the motor vehicle comprises a specific motor vehicle that is identified by a unique identifier such as its vehicle identification number (“VIN”).

In a second aspect, embodiments of the present invention relate to a method of dynamically preparing a Repair Plan for repairing a damaged vehicle In some embodiments, the method includes: generating, by a mapping engine, an interactive (e.g., 3D) image of a motor vehicle that includes OEM repair procedures; rendering, by the mapping engine, the image on a user interface; and overlaying, by a tagging engine, the image with metadata to enhance the OEM repair procedures.

In a third aspect, embodiments of the present invention relate to a system for dynamically preparing an image-based Repair Plan for repairing a damaged vehicle. In some embodiments, the system includes: a mapping engine structured and arranged to render OEM repair procedures on an (e.g., three-dimensional) image of a motor vehicle on a user interface; a tagging engine configured to overlay the OEM repair procedures with repair enhancing metadata; an analytics engine adapted to perform calculations and analyses on all data collected by the system; a decision support engine adapted to perform at least one of augmented or predictive repair planning; an experience and configuration engine adapted to provide data on at least one of: a level of technical experience of at least one repair technician or established parameters for the repair of the damaged vehicle; and a procedure content engine adapted to ingest and update repair procedures.

In some implementations, the decision support engine includes an interactive decision support engine that is structured and arranged to prompt at least one of a repair planner or a repair technician to add discrete procedures to and/or delete discrete procedures from the repair plan; and/or to automatically add discrete procedures to or delete discrete procedures from the repair plan as other discrete procedures are added or deleted. In some variations, the decision support engine includes an interactive decision support engine that is structured and arranged to provide a text-based, visual, video, and/or audio-enabled virtual assistant to interact with a repair planner and/or a repair technician.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a platform to address the collision repair of a specific damaged vehicle, in accordance with some embodiments of the present invention;

FIG. 2 shows a mapped three-dimensional image of a motor vehicle, in accordance with some embodiments of the present invention;

FIG. 3 shows a RP that has been tagged with metadata, in accordance with some embodiments of the present invention; and

FIG. 4 shows a flow chart of a method of dynamically preparing a Repair Plan for repairing a Damaged Vehicle, in accordance with some embodiments of the present invention.

### DETAILED DESCRIPTION

Platform for an Image-Based Repair Plan

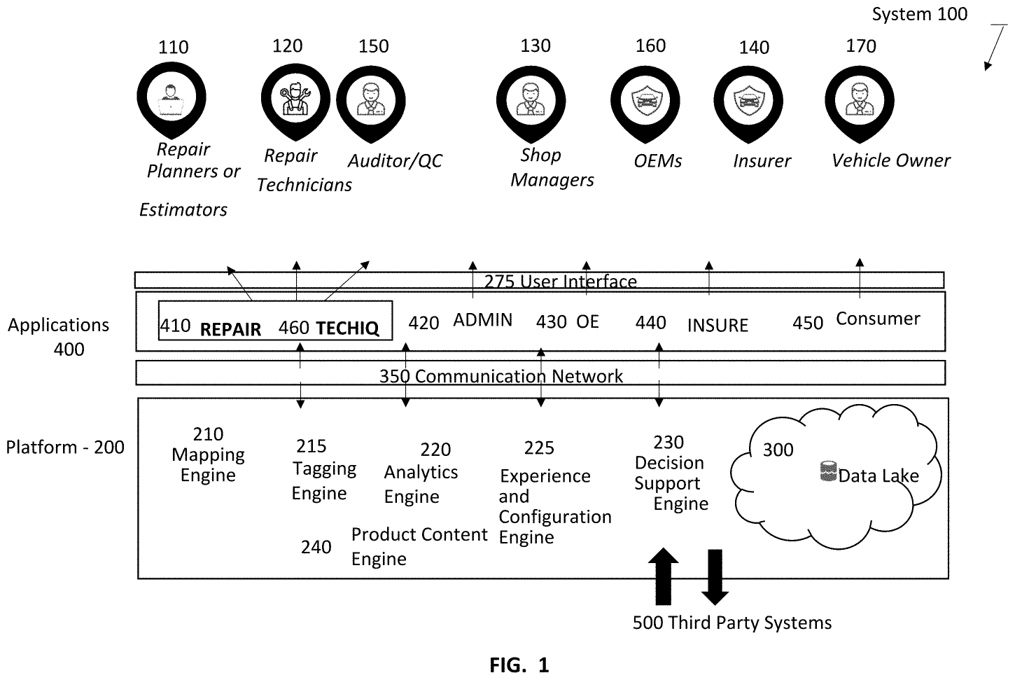

Referring to FIG. 1, an exemplary architecture of a system 100 and a platform 200 to address the repair of a Damaged Vehicle, more specifically, a system 100 and a platform 200 for providing Repair Planning is shown. In some embodiments, the system 100 includes a platform 200, a plurality of user interfaces (“UIs”) 275, a data lake 300, and a suite of applications 400 that are in electronic communication with each other via a wireless or hard-wired communication network 350.

In some applications, elements of the system 100 are in electronic communication, e.g., wirelessly (e.g., via communication network 350) with a plurality of third-party systems 500 offering, for example, communication with an insurer 140, an auditor or quality control person 150, an OEM 160, and the like. Specifically, the auditor or quality control person 150 may be internal (e.g., an employee) or a third-party, and may perform audit functions or provide oversight during and/or after the completion of the repairs. Although FIG. 1 shows a single communication network 350, those of ordinary skill in the art can appreciate that the communication network 350 may, in some implementations, comprise a collection of networks, and is not to be construed as limiting the invention in any way. Moreover, multiple architectural components of the system 100 may belong to the same server hardware. Those of ordinary skill in the art can also appreciate that the platform 200 can be embodied as a single device or as a combination of devices.

The external (to the system core) communication network 350 may include any communication network through which system or network components may exchange data, e.g., the World, Wide Web, the Internet, an intranet, a wide area network (WAN), a local area network (LAN), and so forth. To exchange data via the communication network 350, the applications 400, the platform 200, and the UIs 275 may use various methods, protocols, and standards, including, inter alia, Ethernet, TCP/IP, UDP, HTTP, and/or FTP. The servers and processing devices may include a commercially-available processor such as an Intel Core, Motorola PowerPC, MIPS, UltraSPARC, or Hewlett-Packard PA-RISC processor, but also may be any type of processor or controller as many other processors, microprocessors, and controllers are available. There are many examples of processors currently in use, including network appliances, personal computers, workstations, mainframes, networked clients, servers, media servers, application servers, database servers, and web servers. Other examples of processors may include mobile computing devices, such as cellphones, smart phones, Google Glasses, Microsoft HoloLens, tablet computers, laptop computers, personal digital assistants, and network equipment, such as load balancers, routers, and switches.

The applications 400 and UIs 275 may include operating systems that manage at least a portion of the hardware elements included therein. Usually, a processing device or controller executes an operating system which may be, for example, a Windows-based operating system (e.g., Windows 7, Windows 10, Windows 2000 (Windows ME), Windows XP operating systems, and the like, available from the Microsoft Corporation), a MAC OS System X operating system available from Apple Computer, a Linux-based operating system distributions (e.g., the Alpine, Bionic, or Enterprise Linux operating system, available from Red Hat Inc.), Kubernetes available from Google, or a UNIX operating system available from various sources. Many other operating systems may be used, and embodiments are not limited to any particular implementation. Operating systems conventionally may be stored in memory.

The processor or processing device and the operating system together define a processing platform for which application programs in high-level programming languages may be written. These component applications may be executable, intermediate (for example, C-) or interpreted code which communicate over a communication network (for example, the Internet) using a communication protocol (for example, TCP/IP). Similarly, aspects in accordance with the present invention may be implemented using an object-oriented programming language, such as SmallTalk, Java, JavaScript, C++, Ada, .Net Core C# (C-Sharp), or Python. Other object-oriented programming languages may also be used. Alternatively, functional, scripting, or logical programming languages may be used. For instance, aspects of the system may be implemented using an existing commercial product, such as, for example, Database Management Systems such as SQL Server available from Microsoft of Seattle, Wash., and Oracle Database from Oracle of Redwood Shores, Calif. or integration software such as Web Sphere middleware from IBM of Armonk, N.Y. However, a computer system running, for example, SQL Server may be able to support both aspects in accordance with the present invention and databases for various applications not within the scope of the invention. In one or more of the embodiments of the present invention, the processor or processing device is adapted to execute at least one application, algorithm, driver program, and the like, to receive, store, perform mathematical operations on data, and to provide and transmit the data, in their original form and/or, as the data have been manipulated by mathematical operations, to an external communication device for transmission via the communication network 350. The applications, algorithms, driver programs, and the like that the processor or processing device may process and may execute can be stored in “memory” (e.g., a database(s) or data lake 300).

“Memory,” e.g. the data lake 300, may be used for storing programs and data during operation of the platform 200. “Memory” can be multiple components or elements of a data storage device or, in the alternate, can be stand-alone devices. More particularly, “memory” can include volatile storage, e.g., random access memory (RAM), and/or non-volatile storage, e.g., a read-only memory (ROM). The former may be a relatively high performance, volatile, random access memory such as a dynamic random access memory (DRAM) or static memory (SRAM). Various embodiments in accordance with the present invention may organize “memory” into particularized and, in some cases, unique structures to perform the aspects and functions disclosed herein.

The processors or processing devices may also perform functions outside the scope of the invention. In such instances, aspects of the system 100 may be implemented using an existing commercial product, such as, for example, Database Management Systems such as SQL Server available from Microsoft of Seattle, Wash., and Oracle Database (Spatial) from Oracle of Redwood Shores, Calif. or integration software such as Web Sphere middleware from IBM of Armonk, N.Y. However, a computer system running, for example, SQL Server may be able to support both aspects in accordance with the present invention and databases for various applications not within the scope of the invention.

In use, the parties or end users involved in the vehicle repair process may include, for example, automotive repair professionals, which may include a repair planner or estimator 110, as well as a repair technician(s) 120 and a shop manager 130; an insurer 140; an auditor or quality control person 150; the OEM 160; and the vehicle owner 170. Each system end user may access the system 100 and the platform 200 via a (e.g., cloud-based) communication network 350.

In some embodiments, the platform 200 is structured and arranged to support a comprehensive suite of applications 400 and enabling technologies 210, 215, 220, 225, 230, 240, and 300 to facilitate how collision repair professionals and others access and utilize a Repair Plan to repair a Damaged Vehicle. Advantageously, the platform 200 enables the proper and safe repair of the Damaged Vehicle while creating process efficiencies, improving governance/controls, enhancing consumer experience, and so forth. Advantageously, the platform 200 enables tailoring RPs and other procedural content and related analytics in a secure manner irrespective of the user type.

In some implementations, the platform 200 may include a mapping engine 210, a tagging engine 215, an analytics engine 220, an experience and configuration engine 225, a decision support engine 230, and a procedure content engine 240, as well as a plurality of (i.e., the comprehensive suite of) applications 400. Advantageously, as shown in FIG. 1, the mapping engine 210 of the platform 200 is configured to generate and render, e.g., on a UI 275, a Repair Plan that shows and explains specifically how to effect the repair of the Damaged Vehicle through an intuitive and highly visual interface. In pertinent part, the dynamic, Repair Plan provides a digital record (specific to the Damaged Vehicle) of all RPs required to repair the Damaged Vehicle. Because the dynamic Repair Plan enables repair planners/estimators 110, repair technicians 120, and/or shop managers 130 to upload images, videos, and the like of the Damaged Vehicle, including images, videos, and the like taken as it is repaired, the completed Repair Plan may also serve as a record of the Damaged Vehicle's condition and/or the repairs performed on the Damaged Vehicle. Advantageously, the completed dynamic Repair Plan may serve as a “source of record” that provides evidence that the Damaged Vehicle was properly repaired, viz. repaired in accordance with RPs, using OEM-approved parts. As a result, the completed, dynamic Repair Plan may not only validate for the owner 170 (as well as any regulator) that the Damaged Vehicle has been repaired in accordance with the RPs, but also help mitigate any decrease in the value of the Damaged Vehicle typically experienced by motor vehicles that sustain damage—something that might not otherwise have been the case were the repairs not in accordance with RPs, including the OEM parts indicated therein.

Advantageously, identifying the specific vehicle (e.g., by its VIN) enables the system 100 to tailor access to only the RPs specific to the individual vehicle and facilitates saving details of the collision, the damage, the annotated Repair Plan, certification (which may be of the Repair Plan, the completed repairs, the parts used in the repairs, and/or the repair facility), and information about the motor vehicle's history (including accident and registration information) in a data lake 300. Identifying the motor vehicle by its VIN has other advantages. For example, it helps to correctly establish the make, model, and year of manufacture of the vehicle, as well as the nature of the ownership (e.g., purchase versus lease). Additionally, using the VIN makes it possible to identify open recall items associated with the make and model and additional details (e.g., trim, equipment, options, packages, and the like) that were included with the vehicle at the time of purchase or subsequently added. This helps the decision support engine 230 tailor the RPs to the specific vehicle configuration and options.

Repairs completed according to a dynamic Repair Plan may facilitate certification of one or more of: the Repair Plan itself, the completed repairs, the parts used in the repairs, and the repair facility. As such, this facilitates audits (which may be performed remotely) of the repairs (e.g., by the auditor or quality control person 150) and certification of repairs (e.g., using a digital signature, audio recordings, voice confirmations, video recordings and/or pictures). Moreover, digital versioning and change control protocols may be applied to the dynamic Repair Plan so that the completed Repair Plan remains a source of record of the certified Repair Plan (potentially including, for example, parts used). Accordingly, the dynamic Repair Plans may become the industry standard for repair plans.

In some implementations, the Repair Plan may provide an (e.g., a three-dimensional (“3D”)) image of the motor vehicle, further mapping RPs to the rendered (e.g., 3D) image. The Repair Plan may include repair instruction GIFS, video snippets, animations, and the like to visually show repair instructions. The mapping engine 210 facilitates the more accurate and intuitive access to RPs via an intuitive user experience (e.g., using a 3D vehicle image) and, moreover, allows for more rapid injections of new RPs over time.

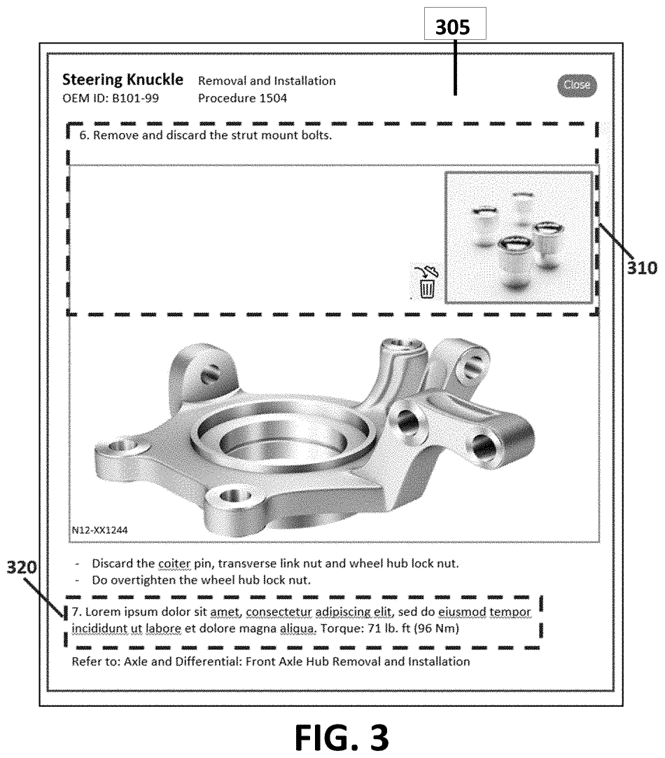

The tagging engine 215 of the platform 200 is adapted to overlay the RPs with repair enhancing metadata and, moreover, to tag selective regions or areas of interest within the RP itself without modifying the source OEM content. This feature provides useful and automated insight to the user (e.g., the repair technician 120), as well as a range of resulting (e.g., safety, revenue, governance) benefits. As shown in FIG. 3, the tagging engine 215 of the platform 200 may be configured to tag RPs 305 and the image of the motor vehicle selectively with metadata, including metadata from third parties. The tagging engine 215 may add any number of metadata tags to the RP (i.e., identification of content in the original, OEM-prepared RP, but not easily identifiable to the user). The tags may include, for example, parts identification 310, torque specifications 320, scanning requirements, calibration requirements, parts information (including one-time use parts), hazardous materials, equipment requirements, test drive criteria, post repair inspection information, whether an operation required more than one person, whether any adjacent panels on the Damaged Vehicle need attention, uncommon material identification (e.g., zinc), and so forth. These metadata, when applied to OEM RP 305, may, inter alia, facilitate generation of repair economics, identify one-time use parts 310, and so forth. In some variations, reverse Repair Planning enables the platform 200, based on a part number or other unique identifier, to identify RPs and other procedural content associated with that part number or unique identifier. This engine may be both human- and machine-modified using AI technologies such as Natural Language Processing and Computer Vision.

The analytics engine 220 of the platform 200 provides a data analysis platform that performs calculations and analyses on all data collected by the platform 200 and each application 400. In some implementations, the experience and configuration engine 225 is adapted to process information about the technical experience of each repair technician 120 who completed repairs on a Damaged Vehicle and to update such information with each Damaged Vehicle that the repair technician 120 works on. Furthermore, the experience and configuration engine 225 is structured and arranged to process configurations or parameters set by the repair facility, OEMs 160, insurer 140, and/or shop managers 130 that are applicable to the repair of a Damaged Vehicle (e.g., target repair times set by the repair facility and labor hours set by the insurer 140).

The decision support engine 230 is an interactive engine adapted to perform augmented and/or predictive repair planning. For example, in some variations, the decision support engine may be structured and arranged to prompt a repair planner 110 to add discrete RPs to, or delete discrete RPs from, the Repair Plan; and/or provide a text-based, visual, video, and/or audio-enabled virtual assistant to interact with a repair planner 110 and/or repair technician 120.

In some implementations, the decision support engine 230 may replace manual repair planning with augmented and/or predictive Repair Planning. More particularly, the decision support engine 230 is capable of predicting and augmenting RPs based on past behavior (e.g., using artificial intelligence techniques) and results from the calculations and analyses performed by the analytics engine 220. Indeed, augmented and/or predictive Repair Planning (e.g., using an analytics engine 220, a decision support engine 230, a processing device/user interface 275 and a data lake 300 containing or storing historical Repair Plans) may include features that include, for the purpose of illustration rather than limitation: automatic determination of RPs or generation of entire Repair Plans based on similar or substantially-similar stored historical Repair Plans; generation of a Repair Plan template based on inputted media (which may include videos, including a video walkaround, and/or photos) of the Damaged Vehicle; an algorithm that is adapted to assign value to preselected conditions (e.g., primary importance, secondary importance, and so forth) within an RP; alerts to repair planners 110, repair technicians 120, and/or shop managers 130 of potential hidden hazards that are not initially observable; recommendations of RPs based on RPs selected by a user; recommendations of potentially missing RPs from a Repair Plan; comparison of a Repair Plan to an insurance estimate for repairs to identify required supplements to the insurance estimate; automatic generation of labor costs and costs for replacement parts; automatic ordering of replacement parts needed for the dynamic Repair Plan; automatic identification of recalled parts and salvage parts used in previous repairs; and the provision of, for example, a text-based, visual, video and/or audio enabled virtual assistant or other AI that, in response to questions, can assist the repair technician 120 to complete a job, can assist the repair planner 110 to build a Repair Plan without the need to manually select RPs, and so forth.

Ultimately, in combination with the analytics engine 220, the augmented and/or predictive Repair Planning feature of the decision support engine 230 may enable a user to generate a high-confidence, dynamic Repair Plan with limited initial input on vehicle damage conditions. Indeed, as the number of repairs and Repair Plans increases, the analytics engine 220 gathers, for example, Repair Plan usage data, job-level record data, anonymized user behavior data, and so forth. The analytics engine 220 may analyze these data to gain insight into the repair process. For the purpose of illustration rather than limitation, these insights may include OEM insights, repair facility insights, insurer insights, vehicle owner insights, insights from the manufacturers, distributors, suppliers, and creators of materials, equipment, supplies and technology utilized in the repair, and so forth.

OEM insights may provide, for example, greater visibility into damage types and parts usage, as well as repair facility-specific performance benchmarks, and may be general in nature or specific to, for example, a temporal period, geographic region, or particular classes or models of vehicles. Repair facility insights may provide information on, for example, cycle time and adherence to RPs at the repair technician level, as well as benchmarking of the proficiency of the various repair technicians within the repair facility. Insurer insights may enable insurers 140 to identify, for example, RPs that might otherwise be missed in an insurance estimate and/or not otherwise considered in the insurance claim. Vehicle owner insights may enable vehicle owners 170 to, for example, have a greater degree of confidence that all necessary repairs were addressed and completed by the repair facility.

The experience and configurations engine 225 provides a processing platform that processes information about the technical experience of each repair technician who completed repairs on a Damaged Vehicle (as such information is inputted into the techiq app 460 and/or the admin app 420), and updates such information with each Damaged Vehicle that the user, such as a repair technician, works on. The information may be displayed to various users via an app; for example: repair planners 110 may access such information via the core repair app 410 to determine which repair technician may have the most applicable experience to work on the Damaged Vehicle; repair technicians 120 may access such information via the techiq app 460 to view an up-to-date record of their technical experience; shop managers 130 may access such information via the admin app 420 to understand the equipment and capacity of the available locations and the technical experience of the repair facility's repair planners and technicians and use this information to, for example, inform their hiring strategies; auditors 150 may access such information via the repair app 410 to gather information on technician or other shop employee credentials; OEMs 160 may access such information via the OE app 430 as part of their selection of repair locations to apply for certification or determination of whether to grant a repair facility certified status; insurers 140 may access such information via the insure app 440 to understand the technical experience of the repair planner and repair technician working on the Damaged Vehicle; and vehicle owners 170 may access such information via the vehicle owner app 450 to understand the experience of the repair technician working on the Damaged Vehicle.

A procedure content engine 240 may be adapted to handle the ingestion and update of RPs in real time, as well as on a scheduled basis. In some variations, the procedure content engine 240 may also version RPs as they are updated, and may automatically notify repair planners 110, repair technicians 120, and/or shop managers 130 of changes to RPs used on Damaged Vehicles that are being repaired, were previously repaired, and/or are scheduled to be repaired. Advantageously, updates from the procedure content engine 240 may be issued as a bulletin until the OEM 160 has the ability to update its RPs and, hence, may not reflect a complete RP change. The procedure content engine 240 may also be adapted to determine whether an update should or should not be included in a Repair Plan based on business rules. For example, a Repair Plan for a completed repair may be set to preserve the RPs as they were when the job was completed even if the RPs subsequently changed.

The suite of applications 400 executable on the platform 200 provide collaborative tools that enable, for example, repair planners 110, repair technicians 120, shop managers 130, insurers 140, and OEMs 160 to share repair plans and to communicate between each other on the RPs contained in the repair plans. Preferably, this enables communication and collaboration throughout the lifetime of the repair. As a result, all of the parties may work in concert on a repair plan so that the completed repair plan may be considered the source of truth for the repair. Moreover, repair technicians 120 are able to access content required to perform a repair that has a higher fidelity than previously possible.

The suite of applications 400 may include, for example, one or more of a core repair app 410, a technician (“techiq”) app 460, a shop administration app 420, an OEM-facing app 430, an insurance-facing app 440, and a vehicle owner-facing app 450. Although these applications 400 will be discussed separately, the platform 200 is a collaborative tool, hence, many of the users may access the data that may be organic to one particular application.

In some implementations, the core repair app 410 is structured to provide an intuitive UI 275 for use by a repair planner 110 to research and identify RPs needed to complete the repairs of a Damaged Vehicle. Advantageously, the core repair app 410 may be configured to provide a digital record of repairs that documents the then-currently needed repairs, as well as the historical repair, of a Damaged Vehicle. Hence, the digital record may become a system of record that may include: timestamps associated with the date and time of research for and execution of the effected repairs; videos, images, and the like of the repairs completed; and confirmative signatures from repair technicians 120 and/or shop managers 130 certifying that RPs contained in the repair plans were completed and OEM or other standards adhered to, and so forth. Moreover, once repairs in a Repair Plan are completed, the digital record may be locked, so that the record may not be altered. Advantageously, because of their digital nature, these Repair Plans may be archived for future use and may be used as a basis for quality control checks, audits, and certification.

The core repair app 410 may also be used to research and discover RPs upon which a Repair Plan may be built, as well as to share the content with other users who may need it. In some implementations, the Repair Plans may contain procedure checklists and signature blocks for confirmatory signatures to authenticate that RPs were completed and adhered to. As such, the core repair app 410 enables the creation of an unlimited number of Repair Plans, each of which may be associated with a discrete vehicle that is identified by a unique identifier for the repair, most typically its VIN.

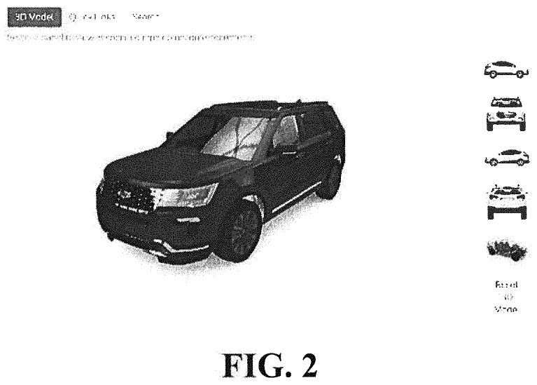

RPs may be mapped to a (e.g., 3D) image of the vehicle like the one shown in FIG. 2 (e.g., via the mapping engine 210) and, ultimately, may become a (e.g., digital) record of the Repair Plan. In some variations, a cross-conditional identification feature may provide internal references associated with the RPs in the core repair app 410, such that, for example, if the repair technician 120 follows RP “X”, the Repair Plan automatically ensures that the repair technician 120 also completes RP “Y”. Cross-conditional identification mitigates the risk of a missed RP, further creating process efficiency.

The core repair app 410 may be used by the repair planner 110, auditor or quality control person 150, shop manager 130, and/or repair technician 120 to mitigate the risk of human error by providing a completely digital record of the repair experience and history for each individual involved in the repair. Depending on the user (e.g., the repair technician 120 or any other party involved in the repair of the Damaged Vehicle), the core repair app 410 may present a different user interface and provide different functionality and/or display different information. For example, in some implementations, the core repair app 410 may be adapted to provide Repair Plan information to the shop manager 130 and/or repair technicians 120 and, moreover, to display the repair plan information on, for example, a UI 275 (e.g., a Google Glass, Microsoft Hololens, and the like). In some variations, the core repair app 410 may include a voice-to-repair plan feature that enables the repair technician 120 to verbally query the core repair app 410 and, furthermore, enables the core repair app 410 to provide a logical response to the repair technician 120 (e.g., via voice and the like). Meanwhile, the techiq app 460 may record and display the technical experience and qualifications of each repair professional who performed repairs on the Damaged Vehicle, thereby also functioning as an electronic record of the repair professional's technical resume that is updated with each Damaged Vehicle the professional works on.

Advantageously, in some implementations, the core repair app 410 may enable an interactive repair plan by which repair technicians 120 may interact with the rendered (e.g., 3D) image and the tagged metadata to execute the workflow. As the repairs proceed, the repair technicians 120 may further interact with the core repair app 410, which documents when and how the repairs were completed. Such information may be used by the system 100 to generate intelligence as to, for example, workflow improvements. Advantageously, the core repair app 410 may enable real-time communication between the repair technicians 120, who are tasked with implementing the Repair Plan, and the repair planner 110, who prepared the Repair Plan.

In some variations, the core repair app 410 identifies for the repair technician 120 parts, tools, machines, safety equipment, hazardous waste disposal, and the like necessary for the repairs. The core repair app 410 also identifies for the shop manager 130 the knowledge, training, human resources, and physical space requirements necessary for identifying the repair technician(s) 120 and the work bay to assign in furtherance of the Repair Plan.

The shop administration app 420 is configured to enable shop-level administration and administration of multi-shop operations, such as, for example, assigning work to repair technicians 120 based on the work to be performed and the competence of the repair technicians 120 available to accomplish the work according to OEM (or other authority) standards and the repair plan, ordering repair parts, providing data on compliance with OEM certification programs, and the like. In some variations, the shop administration app 420 may enable users to perform conventional administrative functions that typically occur in a repair facility, as well as to perform analytics. In some embodiments, the shop administration app 420 identifies for the shop manager 130, for example, the certification, documentation, and jurisdictional regulations necessary for properly completing the Repair Plan. Furthermore, the shop administration app 420 may include a green-lighting capability to assign a repair technician 120 to complete a Repair Plan and/or certain aspects of a Repair Plan based on the technical training and capabilities of the repair technician 120, on the one hand, and prescribed OEM (or other authority) repair and regulatory requirements, on the other hand.

The OEM-facing app 430 is adapted to provide a platform to enable OEMs 160 to provide inputted or derived data describing the incident and/or sustained damage through various media (which may include videos, photos, audio files, and data) to be used to generate the Repair Plan as well as configure, assign, deliver, and/or receive key performance indicators and related analytics. As a result, the OEM-facing app 430 gives OEMs 160 insight into the repair process, enables OEMs 160 to play a direct role in the Repair Planning workflow, as well as create a real-time ticketing system for repair professionals to submit repair feedback through the repair app 410 that the OEMs 160 can use to provide real time guidance and for ongoing improvement initiatives.

The insurance-facing app 440 facilitates sharing Repair Plans with insurers 140, so that the insurers 140 may collect and submit data describing the incident and/or sustained damage through various media (which may include videos, photos, audio files, and data) to be used to generate the Repair Plan, as well as review the RPs and Repair Plans pertaining to an insured vehicle. In some variations, the insurance-facing app 440 also may be used to generate or support the insurance estimate and/or claim processing protocols.

The vehicle owner-facing app 450 facilitates the collection of data describing the incident and/or sustained damage through various media (which may include videos, photos, audio files, and data) to be used in the generation of the Repair Plan, as well as the sharing of documents such as digital certifications (which may include a copy of the completed, annotated Repair Plan used in the repair of the Damaged Vehicle) with the vehicle owner 170 and may also facilitate other communications to the vehicle owner 170 from other users of the platform 200, including repair planners 110, repair technicians 120, shop managers 130, insurers 140 and/or OEMs 160. The sharing of such documents with, and/or the delivery of such communications to, the owner of the Damaged Vehicle may occur either directly within the vehicle owner-facing app 450 or via the vehicle owner-facing app 450 to the vehicle owner's 170 email, text messages, or other communications platforms, or indirectly via a separate application or platform of another end user (e.g., that of shop managers 130, OEMs 160, insurers 140, etc.).

Preferably, the platform 200 and the suite of applications 400 may be securely accessible via a Web (e.g., Internet) browser (e.g., Chrome, Edge Explorer, Safari, and so forth) using the UI 275, or via integrations with third-party systems 500. Cloud-based integration with the OEM(s) 160 ensures that users may access the most up-to-date RPs from one or more OEMs 160. Indeed, one advantage of cloud-based integration is augmented and/or predictive Repair Planning that ensures that, as more and more RPs are created and stored in the data lake 300, the analytics engine 220 and the decision support engine 230 will become increasingly more capable of identifying patterns within those Repair Plans. Thus, Repair Plans based on an initial damage assessment may be created before the Damaged Vehicle arrives at the repair facility and claim documentation and/or the cost estimate of repairs (which may be an insurance estimate) may be generated dynamically.

Method of Dynamically Preparing a Repair Plan for Repairing a Damaged Vehicle

In some embodiments, some aspects of the present invention relate to a method of dynamically preparing a Repair Plan for repairing a Damaged Vehicle. Advantageously, the dynamic nature of the method provides a historical (e.g., digital) source of record for vehicles that may be identified by their VIN or other identifier. More specifically, the source of record provides a record of the RPs and other procedural content required to repair the Damaged Vehicle, as well as, due to its interactive features, a record that the RPs and other procedural content was adhered to by the repair technician(s). Moreover, the dynamic Repair Plan provides, or is a critical component of, a blueprint for repairing a Damaged Vehicle, as well as an aggregation of information detailing the repairs needed and properly completed. Some of the advantages of the described method may include, for the purpose of illustration rather than limitation: improving the organization of (e.g., research) materials at the job level; enabling and/or facilitating management of analyses and jobs at the repair shop(s) level; capturing user-generated content (e.g., notes, images, and/or videos of the Damaged Vehicle and/or damage to the Damaged Vehicle); facilitating determination of job economics; enabling the enforcement of rules and/or related governance associated with the job; and facilitating the certification and/or audit of the repairs.

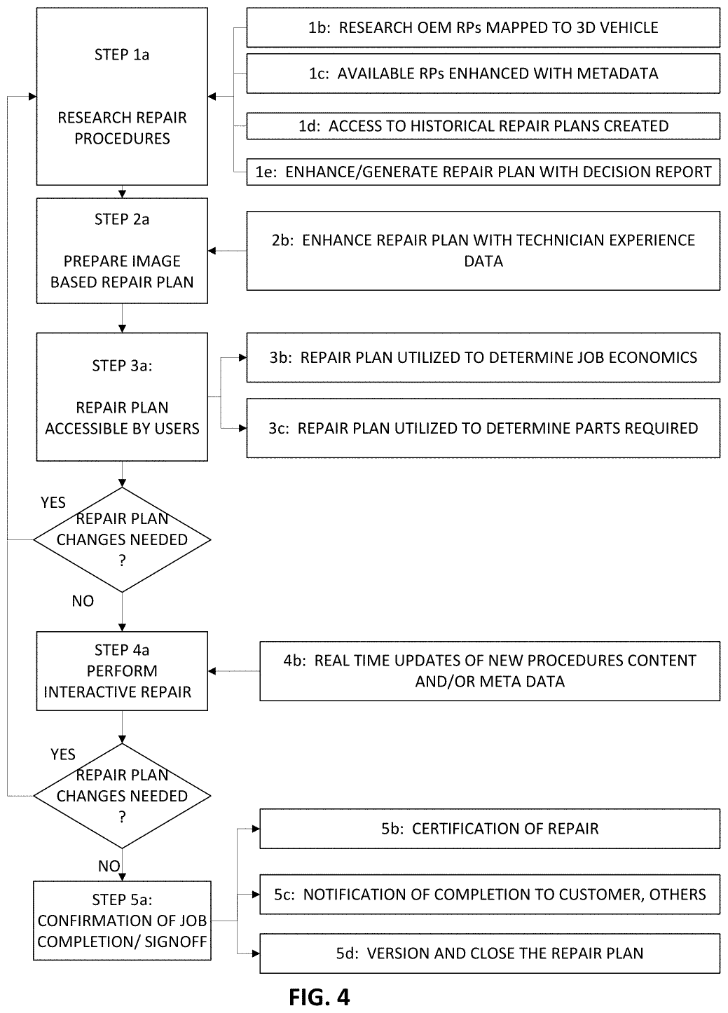

Referring to FIG. 4, an exemplary flow chart depicting an embodiment of a method of repairing a Damaged Vehicle using the above described system 100 is shown. Those of ordinary skill in the art can appreciate that the method includes steps and RPs that may be performed simultaneously or in no particular order, unless expressly described as a condition precedent to another step or RP.

RPs may provide one or more methods of safely and properly repairing the motor vehicle (e.g., according to the OEM 160). RPs, in some instances, may include a collection of information that describes, among other things, how to maintain, repair, replace, inspect, assemble, disassemble, and/or dispose of a part, component, assembly, unit, and the like of a Damaged Vehicle undergoing a repair. The Repair Plan, thus, may be a collection of instructions, information, material, guidelines, requirements, and the like that, collectively, describe and instruct how a repair technician 120 should complete the repairs of the Damaged Vehicle.

In order to make existing RPs from the OEM 160 more usable, and to facilitate the research of RPs (STEP 1a): procedural metadata may be associated (i.e., tagged) to RPs (STEP 1c) and these RPs may, in turn, be mapped to the (e.g., 3D) image of the vehicle, which image may then be used as a graphical means of researching and selecting RPs (STEP 1b); historical Repair Plans may be accessed to aid in RP research efforts (STEP 1d); and/or the Repair Plan may be generated or enhanced by the decision support engine 230 (STEP 1e).

Advantageously, enhancing the RPs mapped to the (e.g., 3D) image of the vehicle with metadata (STEP 1c) does not deleteriously affect the underlying RPs. For the purpose of illustration rather than limitation, metadata attached to the RPs (STEP 1c) may include: computer vision for identifying single-use parts that are listed in repair manuals, RPs, bulletins, and the like; natural language processing (NLP) for identifying single-use parts that are listed in repair manuals, RPs, bulletins, and the like; computer vision for identifying torque specifications listed in repair manuals, RPs, bulletins, and the like; natural language processing (NLP) for identifying torque specifications listed in repair manuals, RPs, bulletins, and the like; computer vision for identifying tools needed to effect repairs that are listed in repair manuals, RPs, bulletins, and the like; natural language processing (NLP) for identifying tools needed to effect repairs listed in repair manuals, RPs, bulletins, and the like; and so forth.

In use, the repair planner 110 may access the system 100 to access, browse, and research available RPs (STEP 1a) from one or multiple OEMs 160, as well as available historical Repair Plans for similar or substantially similar damage to the same or similar make and model of vehicle (STEP 1d), for the purpose of preparing a Repair Plan.

At the same time, data from the decision support engine 230 enables the system 100 to include certain information in the Repair Plan such as the times to complete jobs in the Repair Plan and the repair parts and tools used in the repairs. The decision support engine 230 also enables the system 100 to, at a minimum, tailor the RPs to the Damaged Vehicle and thus facilitate the repair planner's 110 preparation of the Repair Plan, or replace the manual repair planning process with augmented and/or predictive Repair Planning by enabling the user to generate a high-confidence, dynamic Repair Plan with limited input from the repair planner 110. Indeed, in some implementations, algorithms, machine learning, computer intelligence (e.g., computer-aided engineering), and the like may be used to generate a Repair Plan using information, including, for example, damage data input by the repair planner or estimator 110. These damage data may include, for the purpose of illustration rather than limitation: images, videos, and the like of the Damaged Vehicle, as well as descriptions of, for example, the location or point of (e.g., primary, secondary, tertiary, and so forth) impact, severity of the damage, and so forth. A decision support engine 230 may compile these data and, in some variations, assign a value to preselected conditions in the RPs. Based on the scores resulting from the values assigned, the decision support engine 230 may select (or, alternatively, prompt the repair planner 110 to select) discrete RPs for inclusion in the repair plan (STEP 1e) for the Damaged Vehicle. Advantageously, in some embodiments, the decision support engine 230 may prompt the repair planner 110 to select various RPs to include in the Repair Plan, and/or automatically add other RPs that are required by RPs already added to the Repair Plan (STEP 1e). In other variations, the repair planner 110 may access the system 100 to input information about the Damaged Vehicle such as its VIN, and the decision support engine 230 may prompt the repair planner 110 to select from a list of the most common types of damage sustained by similar vehicles (e.g., of the same make and model), and then present the repair planner 110 with RPs applicable to the repair of such damage for inclusion in the Repair Plan (STEP 1e). In short, as increasingly more Repair Plans are prepared, used, and saved to the data lake 300, Repair Planning may become more dynamic and predictive in nature.

Once available RPs have been researched (STEPS 1a, 1b, 1c, 1d, and 1e), the repair planner 110 may prepare a Repair Plan (STEP 2a). This Repair Plan may be enhanced with information about the technical experience of the repair technician 120 who will be completing the repairs on the Damaged Vehicle (STEP 2b). In some applications, the repair planner 110 may use a core repair app 410 from the suite of applications 400 to prepare a Repair Plan (STEP 2a) containing some portion of the researched RPs that have been tailored for the repairs needed for the Damaged Vehicle. Preferably, the Repair Plan provides: detailed RPs (including metadata) for repairing the Damaged Vehicle (for use by the repair technician(s) 120); cost estimates of repairs, which may be insurance estimates (for use by the vehicle owner 170, insurer 140, and auditor or quality control person 150); and technical experience, certifications, and other governances required to properly effect the repairs (for use by the shop manager 130 and auditor or quality control person 150). In some implementations, the Repair Plan is an interactive Repair Plan that can be transmitted for display on a repair technician's UI 275 (STEP 3a), and, additionally, used to determine job economics (STEP 3b) and/or identify the parts that will be required to repair the Damaged Vehicle (STEP 3c). In some variations, the Repair Plan is adapted to display an interactive (e.g., 3D) image of the motor vehicle, as well as instructions on how to properly repair the motor vehicle, including, in some variations, in the form of animations, GIFs, videos, and the like to show directionality and some instructions. For repairs requiring certification, digital certificates may also be provided to the repair technician's UI 275.

Repair shop managers 130 may review the job and assign one or more repair planners 110 to the job. Repair planners 110 may review the Repair Plan and assign all or some portions (i.e. steps) of the Repair Plan to one or more repair technicians 120, depending on the experience level needed to properly repair the motor vehicle and the expertise of the repair technicians 120 available to effect the repairs. In some implementations, the date and time of the assignment to one or more repair technicians 120 may be date and time stamped on the Repair Plan.

As previously mentioned, the Repair Plan may include a (e.g., 3D) image of the vehicle (FIG. 3) that enables users (e.g., the repair planner 110, the repair technician 120, and so forth) to interact with the (e.g., 3D) image (e.g., by clicking on discrete portions or areas of the image, after which the selected sections can be digitally removed from the image). Once an area of the (e.g., 3D) image has been selected (e.g., clicked on), the RPs that apply to that selected area or to the various parts in the selected area can be added to the Repair Plan and subsequently displayed on the (e.g., 3D) image. Advantageously, as RPs are added to the Repair Plan, a quick link(s) that is associated with a discrete area or portion of the (e.g., 3D) image may be automatically created to enable a user to quickly view all procedures that may be applicable to such discrete area or portion of the (e.g., 3D) image.

Even once a Repair Plan has been prepared (STEP 2a) and transmitted to the assigned repair technician's UI 275 or available to others (STEP 3a), the Repair Plan may still be modified if required (e.g., the repair planner 110 and/or the repair technician 120 may notice that required RPs are missing from the Repair Plan). The repair planner 110 may conduct further research of RPs (STEPS 1a, 1b, 1c, 1d, and 1e) before preparing another Repair Plan (STEP 2a) and transmitting the Repair Plan once again to the repair technician's UI 275 and making it available to others (STEP 3a)—this process may be repeated as many times as required. Once no further changes to the Repair Plan are required, the repair technician 120 may begin an interactive (e.g., virtual) repair of the motor vehicle using the interactive “recipe” displayed on the technician's UI 275 (STEP 4a). Each repair technician 120 performs his or her work as defined by the Repair Plan. Advantageously, during repairs, the Repair Plan may receive real time updates of new RPs and/or procedural metadata (STEP 4b), and the repair technician 120 and/or the repair planner 110 may add notes, images, videos, and the like to the Repair Plan to show the stages and quality of the repair, as well as to clarify choices made during the repairs. Advantageously, the interactive repair (STEP 4a) drives repair workflows, enabling the repair technician(s) 120 or others to interact with the (e.g., 3D) image throughout the repairs, and, in some applications, include a voice-to-repair feature that uses, for example, a text-based, visual, video, and/or audio-enabled virtual assistant or other AI to assist the repair technician 120 to complete a job, provide extra information regarding RPs or the Repair Plan, answer the repair technician's questions, and so forth. For example, using the voice-to-repair plan feature, the repair technician 120, once prompted, may verbally instruct the UI 275 to request procurement of or delivery of tools and repair parts to be used or actually used in the completed job. As an alternative to being prompted to do so, the repair technician 120 may proactively input the tools and repair parts used.

At any time during the repairs, the Repair Plan may be modified, and if additional research of RPs is required, the repair planner 110 may conduct such research (STEPS 1a, 1b, 1c, 1d, and 1e); however, any new or revised versions of the Repair Plan that are created after the Repair Plan has been completed and such completion confirmed or signed off on (STEP 5a), will be versioned and saved (e.g., stored as an indication of a completed repair) (STEP 5d) in, or accessible from, the data lake 300 by, for example, a core repair app 410 and/or an administration app 420 that identifies the Damaged Vehicle and the Repair Plan by its identifier (e.g., the Damaged Vehicle's VIN). Should a Damaged Vehicle require additional work subsequent to repair completion (e.g., a vehicle owner 170 returning dissatisfied with the repair), the process can be repeated and a new version saved.

While repairs are being effected, users (e.g., the repair planner 110, the shop manager 130, the vehicle owner 170, and the like) may access the Repair Plan to learn, for example, the progress and interim cost of repairs and to estimate a completion time. For example, upon completion of each element of the Repair Plan, the shop manager 130 or a senior repair technician 120 may confirm that the repair was performed and completed in accordance with the Repair Plan. The shop manager 130 may also use the Repair Plan to ascertain whether any portions of the repairs needing inspection and certification have been completed, so that the shop manager 130 may complete the inspection and necessary certification, for example, by digital certification that can be saved with the Repair Plan (STEP 5a). Once all of the RPs in the Repair Plan have been performed and completed in accordance with the Repair Plan, the Repair Plan is deemed to have been completed.

Once the Repair Plan is completed, the repair planner 110, the shop manager 130 and/or the repair technician 120 may sign off on the completion of the repairs (STEP 5a), and certify that the Repair Plan was created in conformance to OEM requirements (and includes all required RPs) and the Damaged Vehicle was repaired in accordance with such Repair Plan (STEP 5b). At this time, the vehicle owner 170 (or other customer) may also be notified of the completion of the repairs (STEP 5c). Advantageously, once the Repair Plan has been signed off on (STEP 5a), the Repair Plan will be versioned and saved in the data lake 300 (STEP 5d).

The completed, versioned, annotated Repair Plan is usable by many of the users. For example: the annotated Repair Plan enables an auditor or quality control person 150 and/or the insurer 140 to review the Repair Plan that was followed by the repair facility when effecting the repairs, to audit the repairs and the repair technician's 120 adherence to the Repair Plan (and the RPs therein); and the time stamping applied to completion of a discrete job can be compared with the OEM standard to ensure that, based on the time to complete the repair, the repair technician 120, more likely than not, effected the repair in accordance with the RPs and published standards of the OEM 160.

In some variations, the completed, annotated Repair Plan may be saved (e.g., stored) in, or otherwise accessible from, the data lake 300 by (STEP 5d) the vehicle owner app 450 to understand what repairs were completed on the Damaged Vehicle. In other variations, the vehicle owner app 450 may also identify which steps or RPs within the Repair Plan the repair technician 120 is then-performing and/or has already performed on the Damaged Vehicle, along with other information, including estimated time to completion of the repairs, and all such information will update automatically as the repair technician continues performing the repairs.

In some variations, the completed, annotated Repair Plan may be saved (e.g., stored) in (STEP 5d), or otherwise accessible from the data lake 300 by, the OEM app 430 so that OEMs 160 can better understand the areas of repair and other statistics associated with the repair of the Damaged Vehicle. As a result, OEMs 160 may use these data in making future high-level strategic decisions associated with the safe and proper repair of the OEM's vehicles, as well as in forecasting and planning for parts requirements and other potential applications.

A detailed listing of repair parts needed, as well as the cost for those parts and the estimated time for and cost of repairs may be saved (e.g. stored) in, or accessible from the data lake 300 by, the insure app 440 that insurers 140 may access for the purpose of authorizing the repairs of the Damaged Vehicle. In particular, data saved to the insure app 440 may contain: information that explains why certain repair decisions were made based on the RPs; and an insurance waiver that may serve to limit the repair shop's liability by certifying that the repair shop effected the repair of the motor vehicle in accordance with RPs and using OEM parts. The insure app 440 may also capture insurer 140 instructions not to adhere to specific RPs or an otherwise unwillingness to compensate the repairer for activities indicated by the Repair Plan, if applicable.

In some embodiments of the present invention, OEMs 160 may improve their RPs by crowdsourcing their repair procedures, thus creating a feedback loop. More particularly, OEMs 160 may dynamically solicit feedback from repair planners or estimators 110, shop managers 130 and/or repair technicians 120. The OEM app 430 may provide insights from the analytics engine 220 that shows the RPs that, for example, were accessed the most, used in the most Repair Plans, received the highest satisfaction from users, and so forth, for the purpose of formatting, writing, or revising current or future RPs so that they are easier to access, use, and understand by various end users.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. An interactive image-based repair plan for use on a user interface by at least one repair technician to repair a damaged motor vehicle, the repair plan comprising:
an image of a motor vehicle that includes repair procedures from an original equipment manufacturer (OEM); and
metadata tagging that overlays the OEM repair procedures.

2. The repair plan of claim 1, wherein the damaged motor vehicle comprises a specific damaged motor vehicle that is identified by a unique identifier,

3. The repair plan of claim 2, wherein the unique identifier comprises a vehicle identification number.

4. The repair plan of claim 1, wherein the repair plan is annotatable on a user interface to provide a virtual record of the repair plan.

5. The repair plan of claim 1, wherein the repair plan is workflow enabling.

6. The repair plan of claim 1, wherein the image comprises a three-dimensional image,

7. A method of dynamically preparing an image-based repair plan for repairing a damaged vehicle, the method comprising:
generating, by a mapping engine, an interactive image of a motor vehicle that includes OEM repair procedures;
rendering, by the mapping engine, the image on a user interface; and
overlaying, by a tagging engine, the image with metadata to enhance the OEM repair procedures.

8. The method of claim 7, wherein the image comprises a three-dimensional image.

9. A system for dynamically preparing an image-based repair plan for repairing a damaged vehicle, the system comprising:
a mapping engine structured and arranged to render OEM repair procedures on an image of a motor vehicle on a user interface;
a tagging engine configured to overlay the OEM repair procedures with repair enhancing metadata;
an analytics engine adapted to perform calculations and analyses on all data collected by the system;
a decision support engine adapted to perform at least one of augmented or predictive repair planning;
an experience and configuration engine adapted to provide data on at least one of:
a level of technical experience of at least one repair technician or
established parameters for the repair of the damaged vehicle; and
a procedure content engine adapted to ingest and update repair procedures.

10. The system of claim 9, wherein the image comprises a three-dimensional image.

11. The system of claim 9, wherein the decision support engine comprises an interactive decision support engine that is structured and arranged to perform at least one of:
prompt at least one of a repair planner or a repair technician to at least one of add discrete procedures to or delete discrete procedures from the repair plan; and
automatically at least one of add discrete procedures to or delete discrete procedures from the repair plan as other discrete procedures are at least one of added or deleted.

12. The system of claim 9, wherein the decision support engine comprises an interactive decision support engine that is structured and arranged to provide at least one of a text-based, visual, video, or audio-enabled virtual assistant to interact with at least one of a repair planner or a repair technician.
